(19) United States
(12) Patent Application Publication
(10) Pub. No.: US 2026/0360293 A1
(43) Pub. Date: Nov. 12, 2026

(54) DISPLAY PANEL AND DISPLAY DEVICE

(71) Applicant: TIANMA ADVANCED DISPLAY TECHNOLOGY INSTITUTE (XIAMEN) CO., LTD., Xiamen (CN)

(72) Inventor: Yingteng ZHAI, Xiamen (CN)

(21) Appl. No.: 19/388,517

(22) Filed: Nov. 13, 2025

(30) Foreign Application Priority Data
Jun. 30, 2025 (CN) 202510896418.3

(51) Int. Cl. G09G 3/20; G09G 3/3233

(52) U.S. Cl. CPC G09G 3/2011; G09G 3/3233; G09G 2300/0852; G09G 2310/08; G09G 2320/0626

(57) ABSTRACT

Provided are a display panel and a display device. The display panel having a first mode and a second mode includes a pixel circuit and a light-emitting device. The pixel circuit includes a pulse width modulation module configured to modulate a light-emitting duration of the light-emitting device based on a pulse width modulation data voltage and a swept-frequency signal. A brightness of the display panel in the first mode is L1 is smaller than that of the display panel in the second mode. The pulse width modulation module receives a first swept-frequency signal in the first mode and receives a second swept-frequency signal different from the first swept-frequency signal in the second mode. The display panel receives different swept-frequency signals in the first and second modes. The duration of the pixel circuit transmitting the driving current to the light-emitting device is related to the swept-frequency signal.

The present application claims a priority of Chinese patent application No. 202510896418.3, filed on Jun. 30, 2025, the content of which is incorporated herein by reference in its entirety.

### TECHNICAL FIELD

The present disclosure relates to the field of display technologies and, in particular, to a display panel and a display device.

### BACKGROUND

In a display panel, a driving manner in which a pixel circuit drives pixels to emit light includes pulse width modulation (PWM) driving and/or amplitude modulation (PAM) driving. The pulse width modulation driving may control a duration of which the pixel circuit sends a driving current to a light-emitting device in the pixels, making the light-emitting device present corresponding brightness. The pulse width modulation driving causes differences in the duration of which the light-emitting device receives the driving current according to differences in the pulse width modulation data voltage. However, when the display panel is in a low-brightness mode, a maximum pulse width modulation data voltage that the display panel can receive is relatively low. That is, the pulse width modulation data voltage can be allocated within a limited range when the light-emitting device in the display panel displays multiple gray levels in the low-brightness mode, thereby resulting in difficulty in distinguishing the brightness difference when the pixels display adjacent gray levels.

### SUMMARY

In view of this, a display panel and a display device are provided in embodiments of the present disclosure in order to solve the above problems.

In a first aspect, an embodiment of the present disclosure provides a display panel having a first mode and a second mode. The display panel includes a pixel circuit and a light-emitting device. The pixel circuit includes a pulse width modulation module configured to modulate a light-emitting duration of the light-emitting device based on a pulse width modulation data voltage and a swept-frequency signal. A brightness of the display panel in the first mode is L1, a brightness of the display panel in the second mode is L2, and L1<L2. The swept-frequency signal received by the pulse width modulation module in the first mode is a first swept-frequency signal, the swept-frequency signal received by the pulse width modulation module in the second mode is a second swept-frequency signal, and the first swept-frequency signal is different from the second swept-frequency signal.

In a second aspect, an embodiment of the present disclosure provides a display device including a display panel having a first mode and a second mode. The display panel includes a pixel circuit and a light-emitting device. The pixel circuit includes a pulse width modulation module configured to modulate a light-emitting duration of the light-emitting device based on a pulse width modulation data voltage and a swept-frequency signal. A brightness of the display panel in the first mode is L1, a brightness of the display panel in the second mode is L2, and L1<L2. The swept-frequency signal received by the pulse width modulation module in the first mode is a first swept-frequency signal, the swept-frequency signal received by the pulse width modulation module in the second mode is a second swept-frequency signal, and the first swept-frequency signal is different from the second swept-frequency signal.

### BRIEF DESCRIPTION OF DRAWINGS

In order to more clearly illustrate the technical solutions in the embodiments of the present disclosure, the drawings, which are intended to be used in the description of the embodiments, are briefly described as below. It will be apparent that other drawings described below are merely some embodiments of the present disclosure, and other drawings may be obtained by those skilled in the art according to these drawings without any creative efforts.

FIG. 1 is a schematic diagram of a display panel according to an embodiment of the present disclosure;

FIG. 2 is a timing diagram of a display panel according to an embodiment of the present disclosure;

FIG. 3 is a schematic diagram of a pixel circuit according to an embodiment of the present disclosure;

FIG. 4 is a schematic diagram of a pixel circuit according to an embodiment of the present disclosure;

FIG. 5 is an operating timing diagram of the pixel circuit shown in FIG. 3;

FIG. 6 is an operating timing diagram of the pixel circuit shown in FIG. 4;

FIG. 7 is a timing diagram of some signals in a display panel according to an embodiment of the present disclosure;

FIG. 8 is a timing diagram of some signals in a display panel according to an embodiment of the present disclosure;

FIG. 9 is a timing diagram of some signals in a display panel according to an embodiment of the present disclosure;

FIG. 10 is a timing diagram of some signals in a display panel according to an embodiment of the present disclosure;

FIG. 11 is a timing diagram of some signals in a display panel according to an embodiment of the present disclosure;

FIG. 12 is a schematic diagram showing a correspondence between a swept-frequency signal and a brightness segment in a display panel according to an embodiment of the present disclosure;

FIG. 13 is a schematic diagram showing a correspondence between a swept-frequency signal and a brightness segment in a display panel according to an embodiment of the present disclosure;

FIG. 14 is a schematic diagram showing a correspondence between a Gamma curve and a brightness segment in a display panel according to an embodiment of the present disclosure;

FIG. 15 is a timing diagram of part of signals in a display panel according to an embodiment of the present disclosure;

FIG. 16 is a schematic diagram of a display panel according to an embodiment of the present disclosure; and

FIG. 17 is a schematic diagram of a display device according to an embodiment of the present disclosure.

### DESCRIPTION OF EMBODIMENTS

In order to better understand technical solutions of the present disclosure, embodiments of the present disclosure are described in detail below in conjunction with the drawings.

It should be clear that the described embodiments are merely some but not all of the embodiments of the present disclosure. Based on the embodiments of the present disclosure, all other embodiments obtained by those ordinary skilled in the art without creative efforts shall fall within a protection scope of the present disclosure.

Terms used in the embodiments of the present disclosure are merely for the purpose of describing particular embodiments but not intended to limit the present disclosure. Terms “a/an” and “the/said” in a singular form in the embodiments of the present disclosure and the attached claims are also intended to include plural forms thereof, unless explicitly noted otherwise in the context.

It should be understood that the term “and/or” used herein is merely an association relationship describing an associated object, indicating that there may be three relationships, for example, A and/or B, and may indicate: A alone, both A and B, and B alone. In addition, a symbol “/” in the context generally indicates that the relation between the objects prior to and subsequent to “/” is an “or” relationship.

In the description of the present disclosure, it should be understood that terms such as “substantially”, “approximate to”, “approximately”, “about”, “roughly”, “generally” and “in general” described in the claims and embodiments of the present disclosure mean general agreement within a reasonable process operation range or tolerance range, rather than an exact value.

It should be understood that although the terms “first” and “second” may be used in the embodiments of the present disclosure to describe a mode and a brightness segment, which should not be limited to these terms. These terms are only used to distinguish modes and brightness segments from each other. For example, without departing from the scope of the embodiments of the present disclosure, a first mode may also be referred to as a second mode. Similarly, a second mode may also be referred to as a first mode. Through careful and in-depth research, the applicant has provided a solution to the problems existing in the related art.

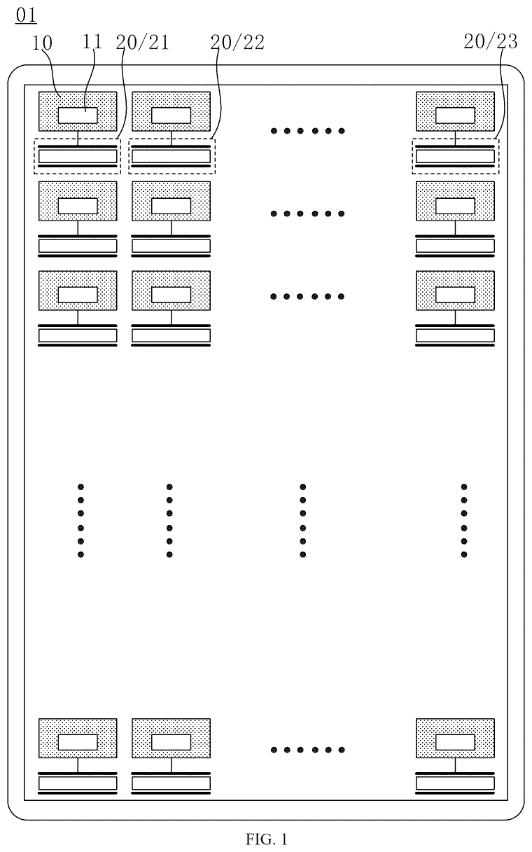

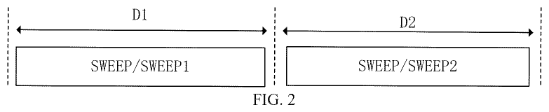

FIG. 1 is a schematic diagram of a display panel according to an embodiment of the present disclosure. FIG. 2 is a timing diagram of a display panel according to an embodiment of the present disclosure.

As shown in FIG. 1, an embodiment of the present disclosure provides a display panel 01 including a pixel circuit 10 and a light-emitting device 20. The pixel circuit 10 is electrically connected to the light-emitting device 20 and can drive the light-emitting device 20 to emit light. The light-emitting device 20 may be at least one of an organic light-emitting diode (OLED), a mini light-emitting diode (Mini-LED), and a micro light-emitting diode (Micro-LED).

With reference to FIG. 1 and FIG. 2, the pixel circuit 10 includes a pulse width modulation module 11 configured to modulate the light-emitting duration of the light-emitting device 20 based on a pulse width modulation data voltage PWM_Data and a swept-frequency signal SWEEP. For example, the pixel circuit 10 may transmit a driving current to the light-emitting device 20 to drive the light-emitting device 20 to emit light, so that the pulse width modulation module 11 is configured to control a duration of which the pixel circuit 10 transmits the driving current to the light-emitting device 20, and the duration may vary based on differences in the pulse width modulation data voltages PWM_Data and different swept-frequency signal SWEEP. In order to facilitate understanding, an example in which the pixel circuit 10 transmits the driving current to the light-emitting device 20 is used for description.

The operating modes of the display panel 01 may include a first mode D1 and a second mode D2. In different operating modes, the display panel 01 may have different brightness. The brightness of the display panel 01 in the first mode D1 is L1, and the brightness of the display panel 01 in the second mode D2 is L2, where L1<L2. The brightness of the display panel 01 in the first mode D1 may be understood as the overall brightness of the display panel 01 in the first mode D1. The brightness of the display panel 01 in the second mode D2 may be understood as the overall brightness of the display panel 01 in the second mode D2. That is, the overall brightness of the display panel 01 when emitting light and displaying in the second mode D2 is greater than the overall brightness of the display panel 01 when emitting light and displaying in the first mode D1. In other words, the maximum brightness of the display panel 01 when displaying the highest gray level in the first mode D1 is B1, and the maximum brightness of the display panel 01 when displaying the highest gray level in the second mode D2 is B2, where B1<B2. In an example, a gray level bit number of the display panel 01 is 8 bits, the brightness that the light-emitting device 20 in the display panel 01 can present may be divided into a totally 256 gray levels from 0 to 255. The brightness presented when the display panel 01 displays gray levels of 0 to 255 in the first mode D1 is lower than the brightness presented when the display panel 01 displays gray levels of 0 to 255 in the second mode D2, and the brightness when the light-emitting device 20 in the display panel 01 presents the gray level of 255 in the first mode D1 is lower than the brightness when the light-emitting device 20 presents the gray level of 255 in the second mode D2.

In some embodiments of the present disclosure, the brightness of the light-emitting device 20 is controlled at least by changing the duration of which the pixel circuit 10 transmits the pixel circuit 10 to the light-emitting device 20. Generally, the brightness of the light-emitting device 20 is positively correlated with the duration of which the light-emitting device 20 receives the driving current. That is, the longer the duration of which the pixel circuit 10 transmits the driving current to the light-emitting device 20 is, the higher the brightness of the light-emitting device 20 is; and the shorter the duration of which the pixel circuit 10 transmits the driving current to the light-emitting device 20 is, the lower the brightness of the light-emitting device 20 is.

In this case, in the first mode D1, the preset duration of which the light-emitting device 20 in the display panel 01 receives the driving current may be within a range between 0 and t1. That is, the maximum duration of which the light-emitting device 20 can receive the driving current when the display panel 01 is in the first mode D1 is t1, and the maximum brightness presented by the light-emitting device 20 at this time corresponds to the maximum gray level value (for example, corresponding to the gray level of 255). Moreover, in the second mode D2, the preset duration of which the light-emitting device 20 in the display panel 01 receives the driving current may be between 0 and t2. That is, the maximum duration of which the light-emitting device 20 can receive the driving current when the display panel 01 is in the second mode D2 is t2, and the maximum brightness presented by the light-emitting device 20 at this time corresponds to the maximum gray level value (for example, corresponding to the gray level of 255). By controlling t1 to be less than t2, the maximum brightness of the light-emitting device 20 in the display panel 01 in the first mode D1 is less than the maximum brightness of the light-emitting device 20 in the display panel 01 in the second mode D2.

The display panel 01 generally has a plurality of operating modes related to brightness to adapt to different application scenarios. Exemplarily, the operating mode of the display panel 01 may be automatically switched when the external ambient light changes. In an example, the operating mode of the display panel 01 when the external ambient light is stronger is different from the operating mode of the display panel 01 when the external ambient light is weaker. For example, when the external ambient light is weaker, one operating mode of the display panel 01 is the first mode D1 with a maximum displayable brightness of B1, and when the external ambient light is stronger, one operating mode of the display panel 01 is the second mode D2 with a maximum displayable brightness of B2, where B1<B2. Exemplarily, the operating mode of the display panel 01 may be automatically switched when the battery power changes. In an example, the operating mode of the display panel 01 when the battery power is higher than the power threshold is different from the operating mode of the display panel 01 when the battery power is lower than the power threshold. For example, when the battery power is lower than the power threshold, an operating mode of the display panel 01 is the first mode D1 with a maximum displayable brightness of B1, and when the battery power is higher than the power threshold, an operating mode of the display panel 01 is the second mode D2 with a maximum displayable brightness of B2, where B1<B2. Exemplarily, the display panel 01 can also switch the operating mode in response to operations of the user. For example, the display panel 01 switches to the corresponding operating mode in response to the user's adjustment of the brightness bar in the operation interface. Accordingly, when the user adjusts the brightness bar from a lower position to an upper position, the display panel 01 can switch from the first mode D1 to the second mode D2, and the maximum displayable brightness of the display panel 01 can be changed from B1 to B2, where B1<B2. For example, the display panel 01 switches to the corresponding operating mode in response to the user's selection of the energy-saving mode. Accordingly, when the user enables the energy-saving mode, the corresponding operating mode is the first mode D1 with the maximum displayable brightness of B1, and when the user disables the energy-saving mode, the corresponding operating mode is the second mode D2 with the maximum displayable brightness of B2, where B1>B2.

It should be noted that the above examples are used to illustrate the operating modes of the display panel 01, especially the first mode D1 and the second mode D2, but the operating modes mentioned in some embodiments of the present disclosure are not limited to the above modes. Further, the operating modes of the display panel 01 mentioned in the embodiments of the present disclosure include the first mode D1 and the second mode D2, which do not refer to just two operating modes of the display panel 01. Instead, the first mode D1 and the second mode D2 are used to represent different operating modes of the display panel 01. In different modes, the display panel 01 may have different brightness. In order to facilitate illustration, in some embodiments, the technical solutions of the embodiments of the present disclosure are mainly described by using an example in which the operating mode of the display panel 01 includes two modes (a first mode D1 and a second mode D2), with the first mode D1 corresponding to a low-brightness mode and the second mode D2 corresponding to a high-brightness mode.

Assuming that the duration of the driving current received by the light-emitting device 20 in the display panel 01 is only determined by the data voltage, since the display panel 01 can receive the data voltage only within a limited range, the lower the brightness corresponding to the operating mode of the display panel 01 is, the narrower the range of the pulse width modulation data voltage PWM_Data that can be received when displaying gray levels between 0 and 255 is. For example, when displaying gray levels between 0 and 255 in the first mode D1, the display panel 01 can receive the pulse width modulation data voltage PWM_Data within the range of 0V to 2V. When displaying gray levels between 0 and 255 in the second mode D2, the display panel 01 can receive the pulse width modulation data voltage PWM_Data within the range of 0V to 5V. It can be seen that the difference between the required pulse width modulation data voltages PWM_Data is smaller when the display panel 01 displays similar gray levels in the low-brightness mode. Therefore, the resolution of the pulse width modulation data voltage PWM_Data of the display panel 01 in the low-brightness mode is low.

Further, since there actually exists losses in the pulse width modulation data voltage PWM_Data, and the loss ratio in the low-brightness mode is greater than the loss ratio in the high-brightness mode, the difference between the actually received pulse width modulation data voltage PWM_Data is smaller when the display panel 01 displays similar gray levels in the low-brightness mode, so that the brightness resolution of the display panel 01 in the low-brightness mode is significantly lower than that in the high-brightness mode.

In the display panel 01 according to the embodiments of the present disclosure, as shown in FIG. 2, the swept-frequency signal SWEEP received by the pulse width modulation module 11 in the first mode D1 is a first swept-frequency signal SWEEP1, and the swept-frequency signal SWEEP received by the pulse width modulation module 11 in the second mode D2 is a second swept-frequency signal SWEEP2. The first swept-frequency signal SWEEP1 is different from the second swept-frequency signal SWEEP2. That is, the swept-frequency signals SWEEP received by the display panel 01 in the low-brightness mode and in the high-brightness mode are different. Therefore, when the light-emitting device 20 presents the identical gray level in both the low-brightness mode and the high-brightness mode, the pulse width modulation data voltage PWM_Data and the swept-frequency signal SWEEP received by the pixel circuit 10 electrically connected thereto in the low-brightness mode are different from the pulse width modulation data voltage PWM_Data and the swept-frequency signal SWEEP received by the pixel circuit 10 electrically connected thereto in the high-brightness mode.

Further, when the display panel 01 is in the same operating mode, the pixel circuit 10 may receive different pulse width modulation data voltages PWM_Data and receive the same swept-frequency signal SWEEP to control the duration for which the pixel circuit 10 transmits the driving current to the light-emitting device 20. For example, when the display panel 01 is in the first mode D1, the pixel circuit 10 may receive a first pulse width modulation data voltage PWM_Data1 and a second pulse width modulation data voltage PWM_Data2, respectively, to control the light-emitting device 20 to receive the driving current for different durations in the first mode D1; and when the display panel 01 is in the second mode D2, the pixel circuit 10 may receive a third pulse width modulation data voltage PWM_Data3 and a fourth pulse width modulation data voltage PWM_Data4, respectively, to control the light-emitting device 20 to receive the driving current for different durations in the second mode D2.

The first swept-frequency signal SWEEP1, relative to the second swept-frequency signal SWEEP2, can make the pixel circuit 10 have a tendency to end transmitting the driving current to the light-emitting device 20 faster. At this time, the range of the pulse width modulation data voltage PWM_Data that the display panel 01 can receive in the low-brightness mode can be appropriately widened. For example, the range of the pulse width modulation data voltage PWM_Data that the display panel 01 can receive when displaying the gray level of 0-255 in the first mode D1 can be widened from 0V-2V to 0V-3V. Correspondingly, except for the gray level of 0, the pulse width modulation data voltage PWM_Data corresponding to the display panel 01 becomes larger when displaying other gray levels in the low-brightness mode, and the difference between the pulse width modulation data voltages PWM_Data actually received by the display panel 01 becomes larger when displaying similar gray levels in the low-brightness mode. Further, since the first swept-frequency signal SWEEP1 may enable the pixel circuit 10 to end transmitting the driving current to the light-emitting device 20 faster, the duration of which the pixel circuit 10 outputs the driving current to the light-emitting device 20 in the first mode D1 may still be substantially between 0 and t1. Therefore, the brightness resolution of the display panel 01 according to the embodiments of the present disclosure in the low-brightness mode is improved.

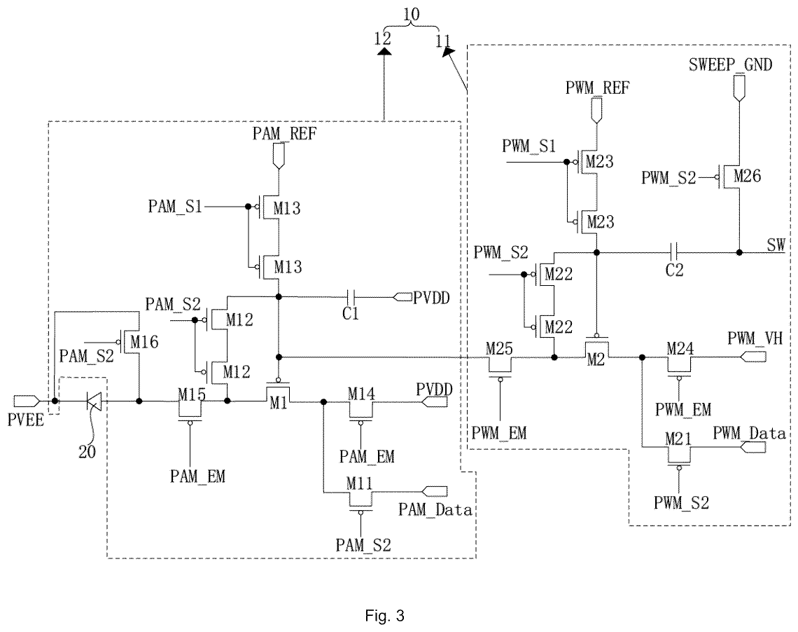

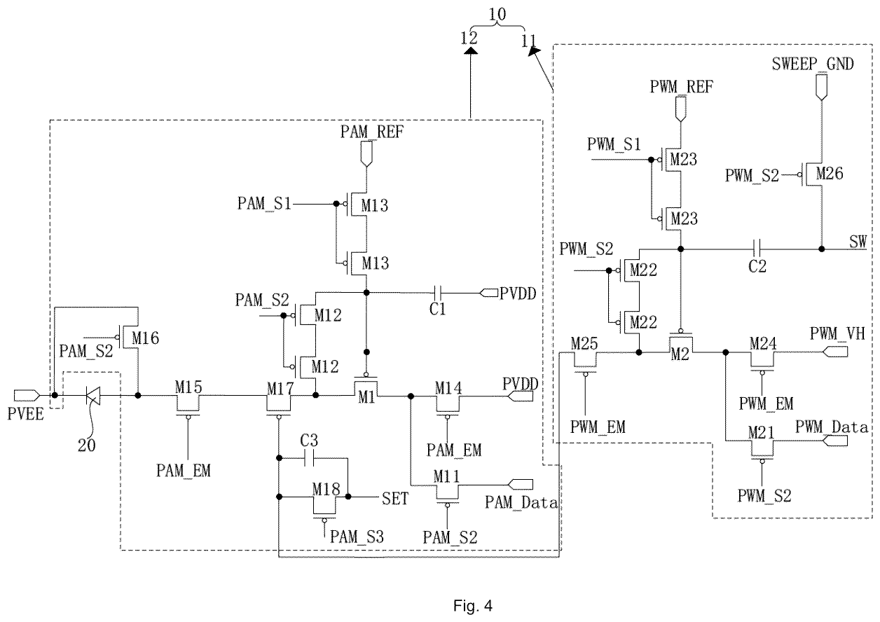

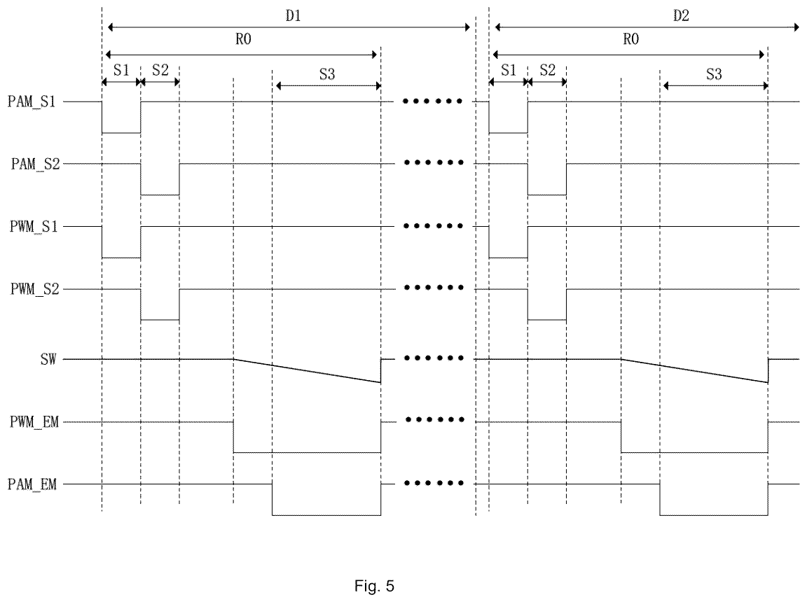

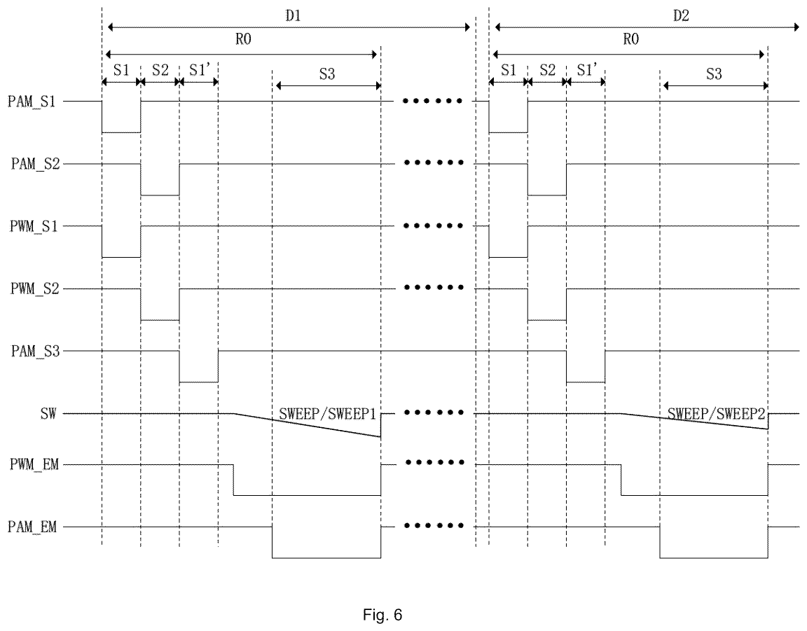

FIG. 3 is a schematic diagram of a pixel circuit related to an embodiment of the present disclosure. FIG. 4 is a schematic diagram of a pixel circuit related to an embodiment of the present disclosure. FIG. 5 is an operating timing diagram of the pixel circuit shown in FIG. 3. FIG. 6 is an operating timing diagram of the pixel circuit shown in FIG. 4.

As shown in FIG. 3 and FIG. 4, the pixel circuit 10 further includes an amplitude modulation module 12 configured to modulate an amplitude of the driving current received by the light-emitting device 20 based on the amplitude modulation data voltage. In some light-emitting devices 20, such as OLEDs, Micro-LEDs, and Mini-LEDs, the light-emitting characteristics of the light-emitting devices 20 may vary due to changes in the amplitude of the received driving current. To avoid such problems, a combination of pulse width modulation driving and amplitude modulation driving may be adopted to reduce the amplitude change frequency of the driving current or eliminate the amplitude change of the driving current. Therefore, an output end of the pulse width modulation module 11 in the pixel circuit 10 is electrically connected to the amplitude modulation module 12. The amplitude modulation module 12 may output a driving current to the light-emitting device 20, and the pulse width modulation module 11 may control the duration of which the amplitude modulation module 12 outputs the driving current to the light-emitting device 20.

Referring to FIG. 3 and FIG. 4 continuously, the amplitude modulation module 12 includes a first driving transistor M1 and a first control transistor M15. The first driving transistor M1 is configured to generate a driving current with a corresponding amplitude based on the amplitude modulation data voltage PAM_Data, and the first control transistor M15 is configured to control the first driving transistor M1 to output the driving current based on the first control signal. When the first control signal received by the first control transistor M15 is at an effective level, the first control transistor M15 is turned on and the first driving transistor M1 can generate a driving current and transmit the driving current to the light-emitting device 20. When the first control signal received by the first control transistor M15 is at an ineffective level, the first control transistor M15 is turned off and no signal is transmitted between the first driving transistor M1 and the light-emitting device 20.

Exemplarily, as shown in FIG. 3, the amplitude modulation module 12 further includes a first data writing transistor M11, a first threshold compensation transistor M12, a first power voltage writing transistor M14, a first reset transistor M13, a second reset transistor M16 and a first capacitor C1. The first data writing transistor M11 has a first electrode configured to receive the amplitude modulation data voltage PAM_Data, a second electrode electrically connected to a first electrode of the first driving transistor M1, and a gate electrically connected to a first scanning line PAM_S2. The first threshold compensation transistor M12 has a first electrode electrically connected to the second electrode of the first driving transistor M1, a second electrode electrically connected to a gate of the first driving transistor M1, and a gate electrically connected to the first scanning line PAM_S2. The first power voltage writing transistor M14 has a first electrode configured to receive a first power voltage PVDD, a second electrode electrically connected to the first electrode of the first driving transistor M1, and a gate electrically connected to the second scanning line PAM_EM. The first control transistor M15 has a first electrode electrically connected to the first electrode of the first driving transistor M1, a second electrode electrically connected to an anode of the light-emitting device 20, and a gate electrically connected to a second scanning line PAM_EM. The second scanning line PAM_EM transmits the first control signal to a gate of the first control transistor M15. The first reset transistor M13 has a first electrode configured to receive a first reset signal PAM_REF, a second electrode electrically connected to the gate of the first driving transistor M1, and a gate electrically connected to a third scanning line PAM_S1. The second reset transistor M16 has a first electrode configured to receive a first reference voltage PVEE, a second electrode electrically connected to a second electrode of the first control transistor M15, and a gate electrically connected to the first scanning line PAM_S2. The first capacitor C1 has a first electrode plate configured to receive the first power voltage PVDD, and a second electrode plate electrically connected to the gate of the first driving transistor M1.

Referring to FIG. 3, the pulse width modulation module 11 further includes a second driving transistor M2 and a second control transistor M25. The second driving transistor M2 is configured to be turned on at a corresponding time based on the pulse width modulation data voltage PWM_Data and the swept-frequency signal SWEEP. The second control transistor M25 is configured to control the second driving transistor M2 to output a turn-off signal to the amplitude modulation module 12 after being turned on based on the second control signal. The turn-off signal may cause the amplitude modulation module 12 to stop transmitting the driving current to the light-emitting device 20. When the second control signal received by the first control transistor M15 is at an effective level, the second control transistor M25 is turned on and the second driving transistor M2 outputs a turn-off signal to the amplitude modulation module 12 after being turned on during the corresponding period. When the first control signal received by the first control transistor M15 is at an ineffective level, the first control transistor M15 is turned off and the second driving transistor M2 no longer transmits the turn-off signal to the amplitude modulation module 12.

Referring to FIG. 3 continuously, the pulse width modulation module 11 further includes a second data writing transistor M21, a second threshold compensation transistor M22, a second power voltage writing transistor M24, a third reset transistor M23, a fourth reset transistor M26 and a second capacitor C2. The second data writing transistor M21 has a first electrode configured to receive the pulse width modulation data voltage PWM_Data, a second electrode electrically connected to a first electrode of the second driving transistor M2, and a gate electrically connected to a fourth scanning line PWM_S2. The second threshold compensation transistor M22 has a first electrode electrically connected to a second electrode of the second driving transistor M2, a second electrode electrically connected to a gate of the second driving transistor M2, and a gate electrically connected to the fourth scanning line PWM_S2. A first electrode of the second power voltage PWM_VH writing the transistor M24 is configured to receive the second power voltage PWM_VH, a second electrode of the second power voltage PWM_VH electrically connected to the first electrode of the second driving transistor M2, and a gate of the second power voltage PWM_VH electrically connected to a fifth scanning line PWM_EM. The second control transistor M25 has a first electrode electrically connected to a first electrode of the second driving transistor M2, a second electrode electrically connected to the gate of the first driving transistor M1, and a gate electrically connected to the fifth scanning line PWM_EM. The fifth scanning line PWM_EM is configured to transmit a second control signal. The third reset transistor M23 has a first electrode configured to receive the second reset signal PWM_REF, a second electrode electrically connected to the gate of the second driving transistor M2, and a gate electrically connected to a sixth scanning line PWM_S1. The second capacitor C2 has a first electrode plate electrically connected to a swept-frequency signal line SW, and a second electrode plate electrically connected to the gate of the second driving transistor M2. The swept-frequency signal line is configured to transmit the swept-frequency signal SWEEP. The fourth reset transistor M26 has a first electrode configured to receive a second reference voltage SWEEP_GND, a second electrode electrically connected to the first electrode plate of the second capacitor C2, and a gate electrically connected to the fourth scanning line PWM_S2.

The operating process of the pixel circuit 10 shown in FIG. 3 is described with reference to FIG. 5. The operating cycle R0 of the pixel circuit 10 includes a reset phase S1, a data voltage writing phase S2 and a light-emitting phase S3. In the reset phase S1, the third scanning line PAM_S1 transmits an effective level (for example, a low level) to control the first reset transistor M13 to be turned on, so as to reset the gate of the first driving transistor M1. The sixth scanning line PWM_S1 transmits an effective level (for example, a low level) to control the third reset transistor M23 to be turned on, so as to reset the gate of the second driving transistor M2. In the data voltage writing phase S2, the first scanning line PAM_S2 transmits an effective level (e.g., a low level) to control the first data writing transistor M11 and the first threshold compensation transistor M12 to be turned on, so as to write the amplitude modulation data voltage PAM_Data into the gate of the first driving transistor M1. The fourth scanning line PWM_S2 transmits an effective level (e.g., a low level) to control the second data writing transistor M21 and the second threshold compensation transistor M22 to be turned on, so as to write the pulse width modulation data voltage PWM_Data into the gate of the second driving transistor. At the same time, the second reset transistor M16 is turned on to reset the anode of the light-emitting device 20, and the fourth reset transistor M26 is turned on to reset the first electrode plate of the second capacitor C2. In the light-emitting phase S3, the second scanning line PAM_EM transmits an effective level (e.g., a low level) to control the first power voltage writing transistor M14 and the first control transistor M15, so that the first driving transistor M1 generates a driving current and transmits the driving current to the light-emitting device 20. The fifth scanning line PWM_EM transmits an effective level (e.g., a low level) to control the second power voltage writing transistor M24 and the second control transistor M25 to be turned on, the swept-frequency signal line SW transmits the swept-frequency signal SWEEP, and the swept-frequency signal SWEEP gradually changes the potential of the gate of the second driving transistor M2 through the second capacitor C2, so that the second driving transistor C2 is turned on at a certain time point and transmits the second power voltage PWM_VH to the gate of the first driving transistor M1 as a turn-off signal, thereby stopping transmitting the driving current to the light-emitting device 20 after turning off the first driving transistor M1. It can be seen that the pulse width modulation module 11 modulates the duration of which the amplitude modulation module 12 outputs the driving current to the light-emitting device 20 by controlling the turn-off time point of the first driving transistor M1.

FIG. 4 shows another pixel circuit 10. The difference between the pixel circuit 10 shown in FIG. 4 and the pixel circuit 10 shown in FIG. 3 is in that FIG. 4 further includes a third control transistor M17, a fifth reset transistor M18, and a third capacitor C3. The third control transistor M17 is electrically connected between the second electrode of the first driving transistor M1 and the light-emitting device 20, and the second electrode of the second control transistor M25 in FIG. 4 is electrically connected to the gate of the third control transistor M17, so that the pulse width modulation module 11 in FIG. 4 modulates the duration of which the amplitude modulation module 12 outputs the driving current to the light-emitting device 20 by controlling the turn-off time point of the third control transistor M17. In an example, the third control transistor M17 has a first electrode electrically connected to the second electrode of the first driving transistor M1, and a second electrode electrically connected to the first electrode of the first control transistor M15. The fifth reset transistor M18 has a first electrode configured to receive the third reset signal VSET, a second electrode electrically connected to the gate of the third control transistor M17, and a gate electrically connected to a seventh scanning line PAM_S3. The second control transistor M25 has a second electrode electrically connected to the gate of the first control transistor M15, and the third capacitor C3 has an electrode plate electrically connected to the gate of the third control transistor M17. Comparing FIG. 6 with FIG. 5, the operating process of the pixel circuit 10 further includes a reset phase S1′, and the seventh scanning line PAM_S3 transmits an effective level (for example, a low level) to control the fifth reset transistor M18 to be turned on, so as to reset the gate of the third control transistor M17 to be turned on. In the light-emitting phase, the swept-frequency signal line SW transmits the swept-frequency signal SWEEP, and the swept-frequency signal SWEEP gradually changes the potential of the gate of the second driving transistor M2 through the second capacitor C2, so that the second driving transistor M2 is turned on at a certain time point and transmits the second power voltage PWM_VH to the third control transistor M17 as a turn-off signal, thereby turning off the third control transistor M17, and blocking the first driving transistor M1 from transmitting the driving current to the light-emitting device 20.

Taking the second driving transistor M2 being a P-channel transistor as an example, when the pulse width modulation data voltage PWM_Data is larger, the swept-frequency signal SWEEP couples the gate of the second driving transistor M2 through the second capacitor C2 to enable the second driving transistor M2 to be turned on longer, that is, the amplitude modulation module 12 has more time to transmit the driving current to the light-emitting unit. When the pulse width modulation data voltage PWM_Data is smaller, the swept-frequency signal SWEEP couples the gate of the second driving transistor M2 through the second capacitor C2 to enable the second driving transistor M2 to be turned on shorter, that is, the amplitude modulation module 12 has less time to transmit the driving current to the light-emitting unit. In some embodiments of the present disclosure, as shown in FIG. 5 and FIG. 6, when the operating mode of the display panel 01 is switched, the swept-frequency signal SWEEP transmitted by the swept-frequency signal line SW to the first electrode plate of the second capacitor C2 of the pulse width modulation module 11 is also different. For example, when the display panel 01 is in the low-brightness mode, compared to the swept-frequency signal SWEEP in the high-brightness mode, the swept-frequency signal SWEEP received by each pixel circuit 10 in the display panel 01 can more easily couple the potential of the gate of the first driving transistor M1 to turn on the first driving transistor M1, so that the pulse width modulation data voltage PWM_Data received by the display panel 01 in the low-brightness mode can be appropriately increased, thereby improving the brightness resolution of the display panel 01 in the low-brightness mode and reducing the impact of the loss of the pulse width modulation data voltage PWM_Data on the brightness resolution.

It should be noted that FIG. 3 and FIG. 4 only exemplarily show two pixel circuits 10, and the technical solutions of the present disclosure may also be applied to other display panels 01 including pixel circuits similar to the pixel circuits 10. Further, since the second driving transistor M2 is a P-channel transistor, the swept-frequency signal SWEEP that controls the second driving transistor M2 to be turned on through the coupling effect is changed from high to low. In some embodiments, when the second driving transistor M2 is an N-channel transistor, the swept-frequency signal SWEEP may also be changed from low to high. An example will be illustrated as below in which the swept-frequency signal SWEEP changed from high to low controls the second driving transistor M2 from turning on to turning off.

Referring to FIG. 5 and FIG. 6, during the operation of the pixel circuit 10, the effective level period (low level period) in the first control signal at least partially overlaps with the swept-frequency signal SWEEP, so as to ensure that the time period in which the first control transistor M15 is turned on overlaps with the time point at which the second driving transistor M2 is turned on, thereby realizing that the pulse width modulation module 11 modulates the duration for which the amplitude modulation module 12 transmits the driving current to the light-emitting device 20.

In an embodiment of the present disclosure, during the operation of the pixel circuit 10, the start time of the swept-frequency signal SWEEP is earlier than the start time of the effective level in the first control signal. That is, in the overlapping period of the swept-frequency signal SWEEP and the first control signal effective level, the swept-frequency signal SWEEP starts to change from high to low before the first control signal becomes the effective level. During the operation of the pixel circuit 10, the start time of the first ramp signal B1 is earlier than the start time of the effective level in the first control signal PAM-EM, that is, earlier than the falling edge of the first control signal PAM-EM. To ensure that the light-emitting device 20 can achieve a non-light-emitting state (that is, display the brightness corresponding to the gray level of 0), the amplitude modulation module 12 may not transmit the driving current to the light-emitting device 20. As a result, the swept-frequency signal SWEEP can transmit a turn-off signal to the amplitude modulation module 12 before the first control transistor M15 is turned on. Therefore, the swept-frequency signal SWEEP begins to transition from high to low before the first control signal reaches the effective level, thereby enabling the second driving transistor M2 to turn on before the first control signal reaches the effective level and to transmit the turn-off signal to the amplitude modulation module 12. Meanwhile, the longer the swept-frequency signal SWEEP lasts, the more accurate the gray level regulation can be achieved.

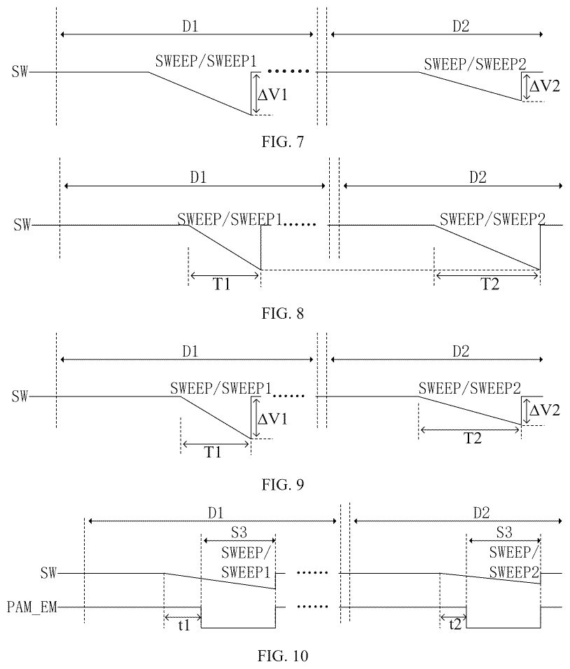

FIG. 7 is a timing diagram of some signals in a display panel according to an embodiment of the present disclosure. FIG. 8 is a timing diagram of some signals in a display panel according to an embodiment of the present disclosure. FIG. 9 is a timing diagram of some signals in a display panel according to an embodiment of the present disclosure.

In an embodiment of the present disclosure, as shown in FIG. 7 to FIG. 9, the rate of change of the voltage of the first swept-frequency signal SWEEP1 over time is greater than the rate of change of the voltage of the second swept-frequency signal SWEEP2 over time, that is, the rate of change of the swept-frequency signal SWEEP received by the display panel 01 in the low-brightness mode over time is greater than the rate of change of the swept-frequency signal SWEEP received by the display panel 01 in the high-brightness mode over time. Therefore, the swept-frequency signal SWEEP received by the display panel 01 in the low-brightness mode can increase the rate of change of the potential of the gate of the second driving transistor M2 from high to low through the coupling effect compared with that in the high-brightness mode, thereby ensuring that the pulse width modulation data voltage PWM_Data received by the second driving transistor M2 can be appropriately increased when the duration of which the amplitude modulation module 12 transmits the driving current to the light-emitting device 20 in the low-brightness mode remains unchanged.

In an embodiment, as shown in FIG. 7, the maximum voltage difference of the first swept-frequency signal SWEEP1 is ΔV1, and the maximum voltage difference of the second swept-frequency signal SWEEP2 is ΔV2, where ΔV1>ΔV2. The maximum voltage difference of the swept-frequency signal SWEEP is the difference between the voltage of the swept-frequency signal SWEEP before changing from high to low and the voltage of the swept-frequency signal SWEEP after changing from high to low. That is, when the display panel 01 is in the low-brightness mode, the voltage of the swept-frequency signal SWEEP received by the pulse width modulation module 11 changes from high to low to a greater extent than in the high-brightness mode. As a result, the rate of change of the voltage of the first swept-frequency signal SWEEP1 over time may be greater than the rate of change of the voltage of the second swept-frequency signal SWEEP2 over time.

In an embodiment, the duration of change of the first swept-frequency signal SWEEP1 may be equal to the duration of change of the second swept-frequency signal SWEEP2. Such solution mainly realizes that the rate of change of the voltage of the first swept-frequency signal SWEEP1 over time may be greater than the rate of change of the voltage of the second swept-frequency signal SWEEP2 over time by configuring the maximum voltage difference between the first swept-frequency signal SWEEP1 and the second swept-frequency signal SWEEP2 to be different. The fact that the duration of change of the first swept-frequency signal SWEEP1 is equal to that of the second swept-frequency signal SWEEP2 may not keep the swept-frequency signal SWEEP in a simple timing sequence, so as to avoid excessively increasing the computing power of the integrated circuit (IC) that drives the display panel 01 to emit light.

In one embodiment, as shown in FIG. 8, the duration of change of the first swept-frequency signal SWEEP1 is T1, and the duration of change of the second swept-frequency signal SWEEP2 is T2, where T1<T2. The duration of change of the swept-frequency signal SWEEP is the duration of change of the swept-frequency signal SWEEP from high to low. That is, when the display panel 01 is in the low-brightness mode, the duration of change of the voltage of the swept-frequency signal SWEEP received by the pulse width modulation module 11 from high to low to a preset voltage is shorter. As a result, the rate of change of the voltage of the first swept-frequency signal SWEEP1 over time may be greater than the rate of change of the voltage of the second swept-frequency signal SWEEP2 over time.

In an embodiment, the maximum voltage difference of the first swept-frequency signal SWEEP1 may be equal to the maximum voltage difference of the second swept-frequency signal SWEEP2. Such a solution mainly realizes that the rate of change of the voltage of the first swept-frequency signal SWEEP1 over time is greater than the rate of change of the voltage of the second swept-frequency signal SWEEP2 over time by configuring the duration of change of the first swept-frequency signal SWEEP1 and the duration of change of the second swept-frequency signal SWEEP2 to be different. The fact that the maximum voltage difference of the first swept-frequency signal SWEEP1 may be equal to the maximum voltage difference of the second swept-frequency signal SWEEP2 can avoid excessively increasing the power consumption of the IC that drives the display panel 01 to emit light.

In an embodiment, as shown in FIG. 9, the maximum voltage difference of the first swept-frequency signal SWEEP1 is ΔV1, and the maximum voltage difference of the second swept-frequency signal SWEEP2 is ΔV2, where ΔV1>ΔV2. Further, the duration of change of the first frequency sweep signal SWEEP1 is T1, and the duration of change of the second frequency sweep signal SWEEP2 is T2, where T1<T2, so as to balance the computing power and power consumption of the IC that drives the display panel 01 to emit light.

In an embodiment of the present disclosure, as shown in FIG. 7 to FIG. 9, the swept-frequency signal SWEEP includes a ramp signal, the first swept-frequency signal SWEEP1 includes a first ramp signal, and the second swept-frequency signal SWEEP2 includes a second ramp signal. A slope of the first ramp signal is greater than a slope of the second ramp signal. That is, the first swept-frequency signal SWEEP1 changes from high to low faster than the second swept-frequency signal SWEEP2 changes from high to low, so that the second driving transistor M2 in the pulse width modulation module 11 turns on faster in the first mode D1 than in the second mode D2.

FIG. 10 is a timing diagram of some signals in a display panel according to an embodiment of the present disclosure.

In an embodiment of the present disclosure, as shown in FIG. 10, during the operation of the pixel circuit 10, a duration between the start time of the first swept-frequency signal SWEEP1 and the start time of an effective level in the first control signal is t1, and a duration between the start time of the second swept-frequency signal SWEEP2 and the start time of an effective level in the first control signal is t2, where t1>t2. That is, with the start time of the light-emitting phase corresponding to each pixel circuit 10 as the reference point, the time point when the same pixel circuit 10 starts to receive the swept-frequency signal SWEEP that changes from high to low when the display panel 01 is in the low-brightness mode is earlier than the time point when the same pixel circuit 10 starts to receive the swept-frequency signal SWEEP that changes from high to low when the display panel 01 is in the high-brightness mode.

With reference to FIG. 10, when the start time of the swept-frequency signal SWEEP is earlier than the start time of the effective level of the first control signal, compared with the second swept-frequency signal SWEEP2, the first swept-frequency signal SWEEP1 has started to change from high to low within a longer period before the effective level of the first control signal starts. That is, with reference to FIG. 3 and FIG. 4, the first swept-frequency signal SWEEP1 has started to pull down the potential of the gate of the second driving transistor M2 from high to low through the second capacitor C2 within a longer period before the effective level of the first control signal starts. Comparing the extent to which the potential of the gate of the second driving transistor M2 in the same pixel circuit 10 has been pulled down from high at the beginning of the light-emitting phase, the extent to which the potential is pulled down from high is greater when the display panel 01 is in the low-brightness mode, and the extent to which the potential is pulled down from high is smaller when the display panel 01 is in the high-brightness mode, thereby ensuring that the pulse width modulation data voltage PWM_Data received by the second driving transistor M2 can be appropriately increased under the circumstance that the duration of which the amplitude modulation module 12 transmits the driving current to the light-emitting device 20 in the low-brightness mode remains unchanged.

In an embodiment, the end time of at least one type of swept-frequency signal SWEEP is later than the end time of the effective level of the first control signal. For example, the end time of the second swept-frequency signal SWEEP2 is later than the end time of the effective level of the first control signal.

In an embodiment, the end time of the first swept-frequency signal SWEEP1 is different from the end time of the second swept-frequency signal SWEEP2. For example, the end time of the first swept-frequency signal SWEEP1 may be identical to the end time of the effective level of the first control signal, and the end time of the second swept-frequency signal SWEEP2 is later than the end time of the effective level of the first control signal. In this case, the durations of the first swept-frequency signal SWEEP1 and the second swept-frequency signal SWEEP2 may be the same. As a result, the driving module can obtain the first swept-frequency signal SWEEP1 and the second swept-frequency signal SWEEP2 by changing the timing sequence of the swept-frequency signals.

In an embodiment, the first swept-frequency signal SWEEP1 and the second swept-frequency signal SWEEP2 have the same end time. For example, the end time of the first swept-frequency signal SWEEP1 is also later than the end time of the effective level of the first control signal.

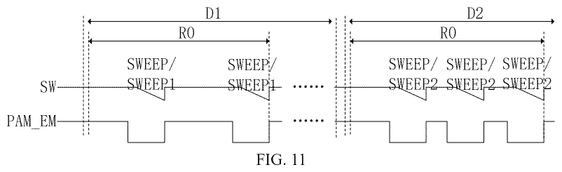

FIG. 11 is a timing diagram of part of the signals in a display panel according to an embodiment of the present disclosure.

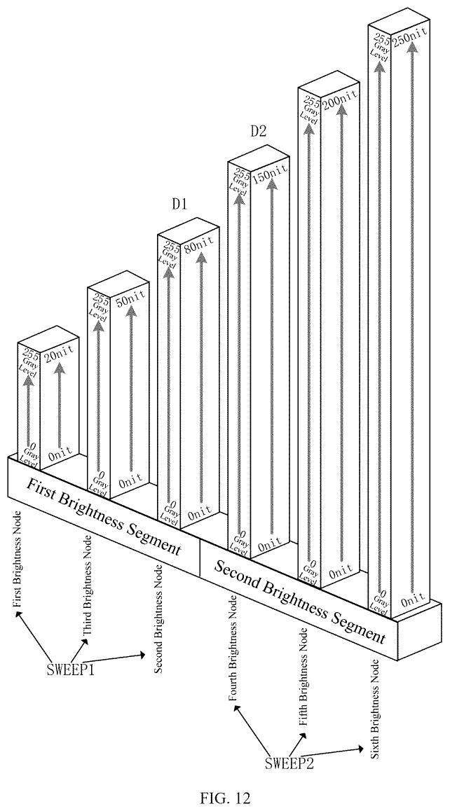

As described above, the light-emitting brightness of the light-emitting device 20 is related to the light-emitting time thereof, and thus the light-emitting brightness of the light-emitting device 20 may be controlled by controlling the light-emitting time of the light-emitting device 20. In an embodiment of the present disclosure, as shown in FIG. 11, within the operating cycle R0 of the display panel 01 during the time of displaying one frame of picture, the number of the times that the first swept-frequency signal SWEEP1 changes is less than the number of the times that the second swept-frequency signal SWEEP2 changes. The number of the times that the swept-frequency signal SWEEP changes is identical to the number of times the first control signal appears at an effective level. As shown in FIG. 11 and FIG. 12, the swept-frequency signal SWEEP corresponds one-to-one with the effective level period of the first control signal. For example, as shown in FIG. 11, within the operating cycle R0 of the display panel 01 during the time of displaying one frame of picture, the pixel circuit 10 receives the swept-frequency signal SWEEP that changes from high to low twice when the display panel 01 is in the first mode D1, and each of the two swept-frequency signals SWEEP overlap one-to-one with the effective level (low level) of the first control signal; and further, the pixel circuit 10 receives the swept-frequency signal SWEEP that changes from high to low three times when the display panel 01 is in the second mode D2, and the three swept-frequency signals SWEEP overlap one-to-one with the effective level (low level) of the first control signal.

In some embodiments, within the operating cycle R0 of the display panel 01 during the time of displaying one frame of picture, the number of times that the light-emitting device 20 in the display panel 01 emits light in the low-brightness mode is less than the number of times that the light-emitting device 20 in the display panel 01 emits light in the high-brightness mode. In this case, the display panel 01 emits light more times in the high-brightness mode, so as to improve the flicker problem of the display panel 01 in the high-brightness mode, and meanwhile, to reduce the number of times that the display panel 01 receives the frequency sweep signal SWEEP in the low-brightness mode, thereby saving power consumption.

FIG. 12 is a schematic diagram showing a correspondence between a swept-frequency signal and a brightness segment in a display panel according to an embodiment of the present disclosure.

In an embodiment of the present disclosure, as shown in FIG. 12, the brightness of the display panel 01 in different operating modes is different. That is, the brightness of the light-emitting device 20 of the display panel 01 when displaying the highest gray level (the gray level of 255) varies in different operating modes. The brightness in some operating modes is approximate to each other. On the basis, the brightness of the display panel 01 is divided into a plurality of brightness segments, so that the brightness of the display panel 01 may include at least two brightness segments. The at least two brightness segments include a first brightness segment and a second brightness segment. For explicitly understanding, a brightness bar that can be adjusted in the operation interface of the display panel 01 may be taken as an example. In response to the user's adjustment to the brightness bar, the display panel 01 switches operating modes. One section in the brightness bar corresponds to one brightness segment. Therefore, the first brightness segment and the second brightness segment may correspond to different non-overlapping sections in the brightness bar.

In some embodiments, each brightness segment includes multiple brightness nodes. For example, the first brightness segment in FIG. 12 includes three brightness nodes: from a first brightness node to a third brightness node, and the second brightness segment includes three brightness nodes: from a fourth brightness node to a sixth brightness node. One brightness node corresponds to one operating mode. For example, the second brightness node in the first brightness segment corresponds to the first mode D1, the first brightness node and the third brightness node in the first brightness segment may respectively correspond to other operating modes, the fourth brightness node in the second brightness segment corresponds to the second mode D2, and the fifth brightness node and the sixth brightness node in the second brightness segment may respectively correspond to other operating modes.

Further, the brightness of the display panel may include a first brightness segment and a second brightness segment, and a brightness of the first brightness segment is lower than a brightness of the second brightness segment. When the operating mode of the display panel is the first mode, the brightness of the display panel may change within the first brightness segment. When the operating mode of the display panel is the second mode, the brightness of the display panel may change within the second brightness segment. One brightness segment may correspond to one operating mode.

In some embodiments, the brightness of the display panel 01 in the first brightness segment is lower than the brightness of the display panel 01 in the second brightness segment. The brightness for displaying the highest gray level when the operating mode of the display panel 01 corresponds to any brightness node in the first brightness segment is lower than the brightness for displaying the highest gray level when the operating mode of the display panel 01 corresponds to any brightness node in the second brightness segment. For example, as shown in FIG. 12, when the operating mode of the display panel 01 corresponds to three brightness nodes in the first brightness segment, the brightness of the light-emitting device 20 displaying the gray level of 255 is 20 nit, 50 nit and 80 nit, respectively. When the operating mode of the display panel 01 corresponds to three brightness nodes in the second brightness segment, the brightness of the light-emitting device 20 displaying the gray level of 255 is 150 nit, 200 nit and 250 nit, respectively. As a result, the maximum brightness that the display panel 01 can display in the first brightness segment is less than that in the second brightness segment.

In the first brightness segment, the swept-frequency signals SWEEP are the same. In the second brightness segment, the swept-frequency signals SWEEP are the same. The swept-frequency signals SWEEP in the first brightness segment are different from the swept-frequency signals SWEEP in the second brightness segment. That is, the received swept-frequency signal SWEEP when the brightness node corresponding to the operating mode of the display panel 01 belongs to the first brightness segment is different from the received swept-frequency signal SWEEP when the brightness node corresponding to the operating mode of the display panel 01 belongs to the second brightness segment. For example, as shown in FIG. 12, the brightness node corresponding to the first mode D1 belongs to the first brightness segment, and the brightness node corresponding to the second mode D2 belongs to the second brightness segment. Since the display panel 01 receives the first swept-frequency signal SWEEP1 in the first mode D1 and receives the second swept-frequency signal SWEEP2 in the second mode D2, the first brightness segment corresponds to the first swept-frequency signal SWEEP1 and the second brightness segment corresponds to the second swept-frequency signal SWEEP2.

In an embodiment, when the brightness of the display panel 01 belongs to the first brightness segment, the display panel 01 receives the first swept-frequency signal SWEEP1. When the brightness of the display panel 01 belongs to the second brightness segment, the display panel 01 receives the second swept-frequency signal SWEEP2.

In the technical solution corresponding to the some embodiments, when a plurality of different operating modes of the display panel 01 correspond to the first brightness segment, the display panel 01 receives the same swept-frequency signal SWEEP when operating in the plurality of operating modes. When a plurality of different operating modes of the display panel 01 correspond to the second brightness segment, the display panel 01 also receives the same further swept-frequency signal SWEEP when operating in the plurality of operating modes. Therefore, the mapping relationship between the swept-frequency signal SWEEP stored in the register for driving the driving device of the display panel 01 and the operating mode is less than the number of the operating modes, thereby avoiding excessive increase in the storage pressure of the register.

Further, within the same brightness segment, the amplitude modulation data voltages PAM_Data received by the pixel circuit 10 may be identical to each other. Within different brightness segments, the amplitude modulation data voltages PAM_Data received by the pixel circuit 10 may be different from each other. That is, when the brightness nodes respectively corresponding to the operating modes of the display panel 01 belong to the same brightness segment, the pixel circuit 10 of the display panel 01 receives the same amplitude modulation data voltage PAM_Data in the operating modes. When the brightness nodes respectively corresponding to at least two operating modes of the display panel 01 belong to different brightness segments, the pixel circuit 10 of the display panel 01 receives different amplitude modulation data voltages PAM_Data in the operating modes. In the operating modes corresponding to the same brightness segment, the display panel 01 receives the same amplitude modulation data voltage PAM_Data, so as to reduce the pressure on the register to store the amplitude modulation data voltage PAM_Data. In different operating modes corresponding to different brightness segments, the display panel 01 receives different amplitude modulation data voltages PAM_Data, so as to widen the range of the pulse width modulation data voltage PWM_Data in the operating mode, especially corresponding to the low-brightness mode, thereby increasing the actual brightness difference corresponding to adjacent gray levels and improving the accuracy of expressing gray levels.

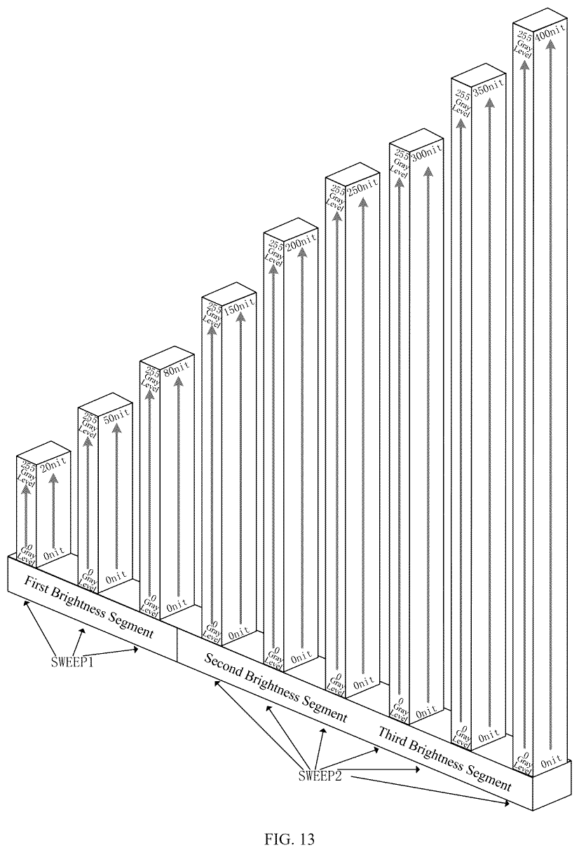

FIG. 13 is a schematic diagram showing a correspondence between a swept-frequency signal and a brightness segment in a display panel according to an embodiment of the present disclosure.

In an embodiment of the present disclosure, as shown in FIG. 13, the brightness of the display panel 01 further includes a third brightness segment, and the brightness of the third brightness segment is greater than the brightness at the second brightness segment. The brightness of the brightness segment has been described in the foregoing embodiments, which will not be repeated herein. In some embodiments, the swept-frequency signal SWEEP in the second brightness segment is identical to the swept-frequency signal SWEEP in the third brightness segment. That is, when different operating modes of the display panel 01 belong to the second brightness segment and the third brightness segment, respectively, the display panel 01 receives the same swept-frequency signal in the different operating modes.

As mentioned above, the brightness of the second brightness segment is greater than the brightness of the first brightness segment, and when the brightness of the third brightness segment is greater than the brightness of the second brightness segment, it means that both the brightness of the second brightness segment and the brightness of the third brightness segment both correspond to the brightness segments with higher brightness of the display panel. In the operating mode corresponding to each brightness node in the brightness segment with high brightness, the maximum value of the pulse width modulation data voltage that the display panel can receive is larger, and the difference in the pulse width modulation data voltages corresponding to adjacent gray levels is also larger. Therefore, the problem of brightness resolution is relatively slight in the brightness segment with high brightness. At this time, the second brightness segment and the third brightness segment share the swept-frequency signal, so as to eliminate significant brightness resolution issues and to reduce the requirements for the storage capacity of the register and the computing power of the driving module.

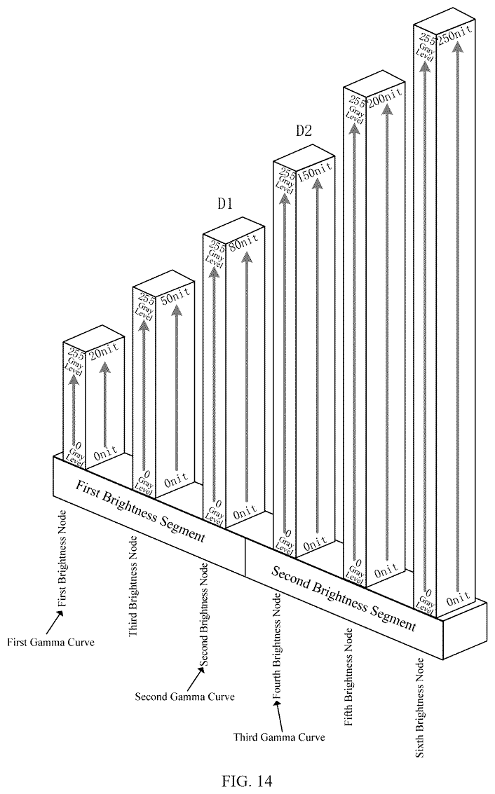

FIG. 14 is a schematic diagram showing a correspondence between a Gamma curve and a brightness segment in a display panel according to an embodiment of the present disclosure.

In an embodiment of the present disclosure, the brightness segment includes a plurality of brightness nodes, that is, the operating modes of the display panel 01 may correspond to the same brightness segment. In these operating modes, the brightness of the light-emitting device 20 in the display panel 01 when displaying the maximum gray level varies. In these operating modes, the pulse width modulation data voltages PWM_Data respectively received by the display panel 01 have different mapping relationships with the gray levels. Therefore, when the display panel 01 operates in the operating modes respectively corresponding to two different brightness nodes within the same brightness segment, the data voltages respectively received by the display panel 01 are obtained by looking up different mapping tables of pulse width modulation data voltages PWM_Data and gray levels. The different mapping tables of pulse width modulation data voltages PWM_Data and gray levels correspond to different Gamma curves.

In other words, the first brightness segment or the second brightness segment includes a first brightness node and a second brightness node, and the brightness at the first brightness node is different from the brightness at the second brightness node. For example, the brightness at the first brightness node is lower than the brightness at the second brightness node. For example, as shown in FIG. 14, the first brightness segment includes a first brightness node and a second brightness node. The pulse width modulation data voltage PWM_Data received by the display panel 01 at the first brightness node corresponds to the first Gamma curve, and the pulse width modulation data voltage PWM_Data received by the display panel 01 at the second brightness node corresponds to the second Gamma curve. That is, when the operating mode of the display panel 01 corresponds to the first brightness node, the pulse width modulation data voltage PWM_Data received by the display panel 01 is obtained by looking up the mapping table corresponding to the first Gamma curve; and when the operating mode of the display panel 01 corresponds to the second brightness node, the pulse width modulation data voltage PWM_Data received by the display panel 01 is obtained by looking up the mapping table corresponding to the second Gamma curve.

In an embodiment, the first brightness segment or the second brightness segment further includes a third brightness node. The brightness of the third brightness node is lower than the brightness at the second brightness node, and the brightness of the third brightness node is greater than the brightness at the first brightness node. For example, as shown in FIG. 14, the first brightness includes a first brightness node, a second brightness node and a third brightness node. The brightness of the light-emitting device 20 in the display panel 01 when displaying the gray level of 255 in the operating mode corresponding to the first brightness node is 20 nit, the brightness of the light-emitting device 20 in the display panel 01 when displaying the gray level of 255 in the operating mode corresponding to the third brightness node is 50 nit, and the brightness of the light-emitting device 20 in the display panel 01 when displaying the gray level of 255 in the operating mode corresponding to the second brightness node is 80 nit.

The pulse width modulation data voltage PWM_Data received by the display panel 01 at the third brightness node is obtained by an interpolation algorithm based on the pulse width modulation data voltage PWM_Data corresponding to the first Gamma curve and the pulse width modulation data voltage PWM_Data corresponding to the second Gamma curve. When the light-emitting device 20 presents the brightness of the same gray level, the pulse width modulation data voltage PWM_Data received by the pixel circuit 10 in the operating mode corresponding to the third brightness node is between the pulse width modulation data voltage PWM_Data received in the operating mode corresponding to the first brightness node and the pulse width modulation data voltage PWM_Data received in the operating mode corresponding to the second brightness node. Therefore, the pulse width modulation data voltage PWM_Data to be received in the operating mode corresponding to the third brightness node may be obtained through an interpolation algorithm.

In an embodiment, the pulse width modulation data voltage PWM_Data to be received by the pixel circuit 10 in the operating mode corresponding to the third brightness node may be obtained in a linear difference manner. Assuming that the first brightness segment includes the above three brightness nodes and the three brightness nodes are evenly distributed in the first brightness segment, the pulse width modulation data voltage PWM_Data received when the pixel circuit 10 drives the light-emitting device 20 to present the brightness corresponding to the gray level of 255 (e.g., 20 nit) in the operating mode corresponding to the first brightness node is 2 V, and the pulse width modulation data voltage PWM_Data received when the pixel circuit 10 drives the light-emitting device 20 to present the brightness corresponding to the gray level of 255 (e.g., 80 nit) in the operating mode corresponding to the second brightness node is 3 V. It could be understood that the horizontal coordinate corresponding to the first brightness node is 1, and the vertical coordinate corresponding to the first brightness node is 2 V; and the horizontal coordinate corresponding to the second brightness node is 3, and the vertical coordinate corresponding to the second brightness node is 3V. The horizontal coordinate corresponding to the third brightness node is 2. It can be obtained in a linear difference manner that the pulse width modulation data voltage PWM_Data to be received by the pixel circuit 10 when driving the light-emitting device 20 to present the brightness corresponding to the gray level of 255 (for example, 50 nit) in the operating mode corresponding to the third brightness node is 2.5 V.

In the solution according to some embodiments, the register may store the pulse width modulation data voltage PWM_Data corresponding to part of the brightness nodes, that is, the register only stores at least part of the pulse width modulation data voltages PWM_Data required in part of operating modes of the display panel 01, so as to avoid causing large storage pressure on the register. The pulse width modulation data voltages PWM_Data required in part of working modes that are not stored in the register is obtained in the linear difference manner, so that the algorithm is simple and the requirement for the computing power of the driving module is not high.

In an embodiment, the pulse width modulation data voltages PWM_Data respectively received by two adjacent brightness nodes in the first brightness segment and the second brightness segment, respectively, correspond to different Gamma curves. The different brightness nodes are sorted by brightness. The mapping relationships between the pulse width modulation data voltages PWM_Data respectively corresponding to two adjacent brightness nodes in two brightness segments and partial gray levels are stored in the register. For example, as shown in FIG. 14, the second brightness node in the first brightness segment is adjacent to the fourth brightness node in the second brightness segment, the second brightness node corresponds to the second Gamma curve, and the fourth brightness node corresponds to the third Gamma curve, so that the register stores the mapping relationship between some pulse width modulation data voltages PWM_Data received by the display panel 01 in the operating mode corresponding to the second brightness node and the gray levels, and the relationship between part of pulse width modulation data voltages PWM_Data received by the display panel 01 in the operating mode corresponding to the fourth brightness node and the gray levels.

Among two adjacent brightness nodes located in two brightness segments, although the brightness of the two brightness nodes is adjacent, the swept-frequency signals SWEEP respectively corresponding to the two brightness nodes may be different due to different brightness segments they belong to. If the pulse width modulation data voltage PWM_Data corresponding to at least one of the two brightness nodes is to be obtained using the linear differential interpolation algorithm, it is also necessary to consider the difference in the swept-frequency signal SWEEP, which requires high computing power, and the obtained result may cause obvious distortion in the light-emitting brightness of the light-emitting device 20.

In an embodiment of the present disclosure, as shown in FIG. 1, the light-emitting device 20 includes a first color light-emitting device 21 and a second color light-emitting device 22. In the first mode D1 or the second mode D2, the swept-frequency signals SWEEP respectively received by the pixel circuit 10 electrically connected to the first color light-emitting device 21 and the pixel circuit 10 electrically connected to the second color light-emitting device 22 are different. Different manners in which the swept-frequency signals SWEEP respectively received by the pixel circuit 10 electrically connected to the first color light-emitting device 21 and the pixel circuit 10 electrically connected to the second color light-emitting device 22 may refer to the differentiated design schemes of the first swept-frequency signal SWEEP1 and the second swept-frequency signal SWEEP2.

The light-emitting devices 20 emitting light of different colors have different light-emitting efficiencies. The swept-frequency signal SWEEP received by the pixel circuits 10 electrically connected to the light-emitting devices 20 of different colors can be adjusted according to actual requirements of the light-emitting devices emitting light of different colors, so as to ensure that the light-emitting devices 20 of different colors of the display panel 01 can have higher brightness resolution, and, in particular, can improve the color shift problem caused by different losses in brightness resolution of light emitted by the light-emitting devices of different colors in the low-brightness mode.

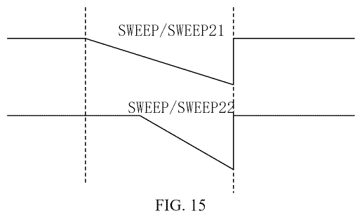

FIG. 15 is a timing diagram of some signals in a display panel according to an embodiment of the present disclosure.

In an embodiment, as shown in FIG. 15, a light-emitting wavelength of the first color light-emitting device 21 is longer than a light-emitting wavelength of the second color light-emitting device 22, and a rate of change of the swept-frequency signal SWEEP21 corresponding to the first color light-emitting device 21 over time is less than a rate of change of the swept-frequency signal SWEEP22 corresponding to the second color light-emitting device 22 over time. The first color light-emitting device 21 may be a red light-emitting device, the second color light-emitting device 22 may be one of a blue light-emitting device and a green light-emitting device. A wavelength of red light is longer than a wavelength of blue light and a wavelength of green light, while a luminous efficiency of the red light-emitting device is less than that of the blue light-emitting device and less than that of the green light-emitting device. Therefore, in a solution corresponding to some embodiments, the luminous efficiency of the first color light-emitting device 21 is less than that of the second color light-emitting device 22. The rate of change of the voltage of the swept-frequency signal received by the pixel circuit 10 electrically connected to the first color light-emitting device 21 with lower luminous efficiency over time should be smaller, so as to delay the time when the pulse width modulation module 11 outputs the turn-off signal to the amplitude modulation module 12, thereby prolonging the time period for the first color light-emitting device 21 to receive the driving current. It should be noted that FIG. 15 shows a form in which the swept-frequency signal SWEEP22 is different from the swept-frequency signal SWEEP21, and the differentiated design of the swept-frequency signal SWEEP22 and the swept-frequency signal SWEEP21 may also refer to the differentiation between the first swept-frequency signal SWEEP1 and the second swept-frequency signal SWEEP2.

In some embodiments, the pixel circuits 10 respectively electrically connected to at least two light-emitting devices 20 of different colors may receive different swept-frequency signals in the same operating mode, and the pixel circuit 10 electrically connected to any one of the at least two light-emitting devices 20 of different colors respectively receives different swept-frequency signals SWEEP in the first mode D1 and the second mode D2. Therefore, in some embodiments of the present disclosure, the brightness resolution of the light-emitting devices 20 of different colors may be specifically improved, thereby improving the color shift problem.

In some embodiment, the display panel 01 may further include a third color light-emitting device 23, and a luminous efficiency of the third color light-emitting device 23 is between the luminous efficiency of the first color light-emitting device 21 and the luminous efficiency of the second color light-emitting device 22, so that the rate of change of the swept-frequency signal SWEEP corresponding to the third color light-emitting device 23 over time may be between the rate of change of the swept-frequency signal SWEEP corresponding to the second color light-emitting device 22 over time and the rate of change of the swept-frequency signal SWEEP corresponding to the first color light-emitting device 21 over time. The first color light-emitting device 21 may be a red light-emitting device, the second color light-emitting device 22 may be a blue light-emitting device, and the third color light-emitting device 23 may be a green light-emitting device.

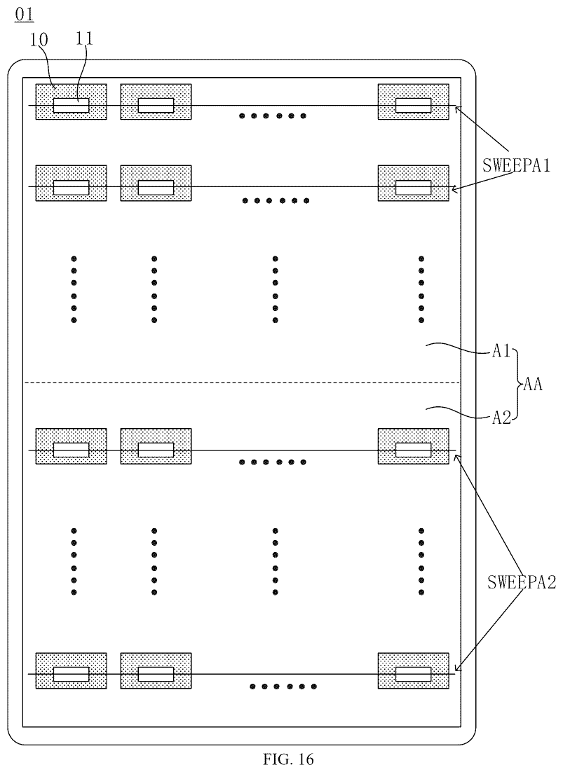

FIG. 16 is a schematic diagram of a display panel according to an embodiment of the present disclosure.

Due to factors such as temperature and voltage drop, the luminous efficiency of the light-emitting devices 20 at different locations within the display panel 01 may vary. As a result, the display area AA of the display panel 01 may be divided into at least two areas, that is, the display area AA of the display panel 01 includes a first display area A1 and a second display area A2. As shown in FIG. 16, in the first mode D1 or the second mode D2, the swept-frequency signals SWEEP received by the first display area A1 are identical, the swept-frequency signals SWEEP received by the second display area A2 are identical, and the swept-frequency signals SWEEP received by the first display area A1 are different from the swept-frequency signals SWEEP received by the second display area A2. For example, the first display area A1 receives the swept-frequency signal SWEEPA1, and the second display area A2 receives the swept-frequency signal SWEEPA2.

In an embodiment, when the display panel 01 is in the first mode D1, the swept-frequency signals SWEEP received by the first display area A1 are identical, the swept-frequency signals SWEEP received by the second display area A2 are identical, and the swept-frequency signals SWEEP received by the first display area A1 are different from the swept-frequency signals SWEEP received by the second display area A2. Moreover, when the display panel 01 is in the second mode D2, the swept-frequency signals SWEEP received by the first display area A1 are identical, the swept-frequency signals SWEEP received by the second display area A2 are identical, and the swept-frequency signals SWEEP received by the first display area A1 are different from the swept-frequency signals SWEEP received by the second display area A2.

In some embodiments, the swept-frequency signal SWEEP received by the pixel circuit 10 electrically connected to the light-emitting devices in different areas of the display panel 01 can be specifically adjusted according to the luminous performance of the light-emitting devices 20 at different positions of the display area AA in the display panel 01 and actual requirements, so as to ensure that the light-emitting devices 20 in different areas of the display panel 01 can achieve higher brightness resolution, thereby improving display uniformity.

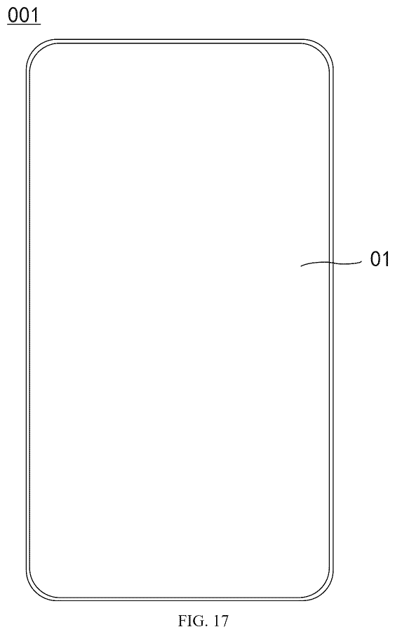

FIG. 17 is a schematic diagram of a display device according to an embodiment of the present disclosure.

As shown in FIG. 17, an embodiment of the present disclosure further provides a display device 001, including the display panel 01 according to any of the above embodiments. It should be understood that the display device 001 shown in FIG. 17 is merely illustrative, and the display device 001 may be any electronic device having a display function, such as a mobile phone, a tablet computer, a notebook computer, an e-book, a television, and a spliced display device. The display device 001 according to the embodiments of the present disclosure has good brightness resolution.

The above descriptions are merely preferred embodiments of the present disclosure and are not intended to limit the present disclosure. It should be noted that any modifications, equivalent substitutions, improvements, and the like made within the spirit and principle of the present disclosure shall fall within the scope of the present disclosure.

What is claimed is:

1. A display panel having a first mode and a second mode, comprising a pixel circuit and a light-emitting device, wherein
the pixel circuit comprises a pulse width modulation module configured to modulate a light-emitting duration of the light-emitting device based on a pulse width modulation data voltage and swept-frequency signals;
a brightness of the display panel in the first mode is L1, a brightness of the display panel in the second mode is L2, and L1<L2; and
a swept-frequency signal received by the pulse width modulation module in the first mode is a first swept-frequency signal, a swept-frequency signal received by the pulse width modulation module in the second mode is a second swept-frequency signal, and the first swept-frequency signal is different from the second swept-frequency signal.

2. The display panel according to claim 1, wherein
a rate of change of a voltage of the first swept-frequency signal over time is greater than a rate of change of a voltage of the second swept-frequency signal over time.

3. The display panel according to claim 2, wherein
a duration of change of the first swept-frequency signal is T1, a duration of change of the second swept-frequency signal is T2, and T1<T2.

4. The display panel according to claim 2, wherein
a maximum voltage difference of the first swept-frequency signal is ΔV1, a maximum voltage difference of the second swept-frequency signal is ΔV2, and ΔV1>ΔV2.

5. The display panel according to claim 1, wherein
the first swept-frequency signal comprises a first ramp signal, and the second swept-frequency signal comprises a second ramp signal; and
a slope of the first ramp signal is greater than a slope of the second ramp signal.

6. The display panel according to claim 1, wherein
within one frame time of the display panel, a number of times that the first swept-frequency signal changes is less than a number of times that the second swept-frequency signal changes.

7. The display panel according to claim 1, wherein
the brightness of the display panel comprises a first brightness segment and a second brightness segment, and a brightness of the display panel within the first brightness segment is lower than a brightness of the display panel within the second brightness segment; and
swept-frequency signals within the first brightness segment of the brightness of the display panel are identical to each other; swept-frequency signals within the second brightness segment of the brightness of the display panel are identical to each other; and the swept-frequency signals within the first brightness segment of the brightness of the display panel are different from the swept-frequency signals within the second brightness segment of the brightness of the display panel.

8. The display panel according to claim 7, wherein
the brightness of the display panel further comprises a third brightness segment, and a brightness of the display panel within the third brightness segment is greater than the brightness of the display panel within the second brightness segment; and
the swept-frequency signals in the second brightness segment are identical to swept-frequency signals in the third brightness segment.

9. The display panel according to claim 7, wherein
the first brightness segment or the second brightness segment comprises a first brightness node and a second brightness node, and a brightness at the first brightness node is lower than a brightness at the second brightness node; and
the pulse width modulation data voltage received by the display panel at the first brightness node corresponds to a first Gamma curve, and the pulse width modulation data voltage received by the display panel at the second brightness node corresponds to a second Gamma curve.

10. The display panel according to claim 9, wherein
the first brightness segment or the second brightness segment further comprises a third brightness node, a brightness at the third brightness node is lower than the brightness at the second brightness node, and the brightness at the third brightness node is greater than the brightness at the first brightness node; and
the pulse width modulation data voltage received by the display panel at the third brightness node is obtained through an interpolation algorithm based on the pulse width modulation data voltage corresponding to the first Gamma curve and the pulse width modulation data voltage corresponding to the second Gamma curve.

11. The display panel according to claim 9, wherein pulse width modulation data voltages that are respectively received by two adjacent brightness nodes in the first brightness segment and the second brightness segment correspond to different Gamma curves.

12. The display panel according to claim 1, wherein
the light-emitting device comprises a first color light-emitting device and a second color light-emitting device; and
in the first mode or the second mode, the pixel circuit electrically connected to the first color light-emitting device and the pixel circuit electrically connected to the second color light-emitting device receive different swept-frequency signals.

13. The display panel according to claim 12, wherein
a light-emitting wavelength of the first color light-emitting device is greater than a light-emitting wavelength of the second color light-emitting device, and a rate of change of a voltage of a swept-frequency signal corresponding to the first color light-emitting device over time is less than a rate of change of a voltage of a swept-frequency signal corresponding to the second color light-emitting device over time.

14. The display panel according to claim 1, wherein a display area of the display panel comprises a first display area and a second display area, and
wherein in the first mode or the second mode, swept-frequency signals received by the first display area are identical to each other, swept-frequency signals received by the second display area are identical to each other, and the swept-frequency signals received by the first display area are different from the swept-frequency signals received by the second display area.

15. The display panel according to claim 1, wherein
the pixel circuit further comprises an amplitude modulation module configured to modulate an amplitude of a driving current received by the light-emitting device based on an amplitude modulation data voltage, an output end of the pulse width modulation module is electrically connected to the amplitude modulation module;
the amplitude modulation module comprises a first driving transistor and a first control transistor, the first driving transistor is electrically connected to the first control transistor, and the first control transistor is configured to control the first driving transistor to output the driving current based on a first control signal; and
during operation of the pixel circuit, an effective level period in the first control signal at least partially overlaps with the swept-frequency signals.

16. The display panel according to claim 15, wherein
during operation of the pixel circuit, start times of the swept-frequency signals are all earlier than a start time of an effective level in the first control signal.

17. The display panel according to claim 16, wherein
during operation of the pixel circuit, a duration from a start time of the first swept-frequency signal to the start time of the effective level in the first control signal is t1, a duration from a start time of the second swept-frequency signal to the start time of the effective level in the first control signal is t2, and t1>t2.

18. The display panel according to claim 16, wherein
an end time of at least part of the swept-frequency signals is later than an end time of the effective level in the first control signal.

19. The display panel according to claim 18, wherein
an end time of the first swept-frequency signal is different from an end time of the second swept-frequency signal.

20. A display device, comprising a display panel having a first mode and a second mode, wherein the display panel comprises a pixel circuit and a light-emitting device;
the pixel circuit comprises a pulse width modulation module configured to modulate a light-emitting duration of the light-emitting device based on a pulse width modulation data voltage and swept-frequency signals;
a brightness of the display panel in the first mode is L1, a brightness of the display panel in the second mode is L2, and L1<L2; and
a swept-frequency signal received by the pulse width modulation module in the first mode is a first swept-frequency signal, a swept-frequency signal received by the pulse width modulation module in the second mode is a second swept-frequency signal, and the first swept-frequency signal is different from the second swept-frequency signal.
